(19) United States
(12) Patent Application Publication
(10) Pub. No.: US 2008/0103842 A1
(43) Pub. Date: May 1, 2008

(54) TRAVEL COST ESTIMATING

(76) Inventor: Michael J. Johnson, Chandler, AZ (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/552,722

(22) Filed: Oct. 25, 2006

(51) Int. Cl. G06Q 10/00

(52) U.S. Cl. 705/5

(57) ABSTRACT

In one aspect, the invention is a method to estimate travel costs using a spreadsheet application. The method includes receiving inputs in a spreadsheet file using the spreadsheet application. The user inputs include an origination, a destination, a start date and an end date. The method also includes storing prices in the spreadsheet file, determining a travel cost estimate based on the inputs and the stored prices and rendering the travel cost estimate in the spreadsheet file.

### TECHNICAL FIELD

The invention relates to travel cost estimating.

### BACKGROUND

Travel cost estimates are used by companies to make bids on projects and contracts. Most companies and the Federal Government receiving bids generally require companies making the bids to have consistency in their travel cost estimates. For example, when a government audit agency reviews a company's records, the agency checks for consistency in pricing throughout the company on its bids to the government. Companies not having consistent pricing in their bids are often penalized.

### SUMMARY

In one aspect, the invention is a method to estimate travel costs using a spreadsheet application. The method includes receiving inputs in a spreadsheet file using the spreadsheet application. The user inputs include an origination, a destination, a start date and an end date. The method also includes storing prices in the spreadsheet file, determining a travel cost estimate based on the inputs and the stored prices and rendering the travel cost estimate in the spreadsheet file.

In another aspect, the invention is an article including a machine-readable medium that stores executable instructions to estimate travel costs. The instructions cause a machine to receive inputs in a spreadsheet file using the spreadsheet application. The user inputs include an origination, a destination, a start date and an end date. The instructions also include instructions causing a machine to store prices in the spreadsheet file, determine a travel cost estimate based on the inputs and the stored prices and render the travel cost estimate in the spreadsheet file.

In a further aspect, the invention is an apparatus to estimate travel costs. The apparatus includes circuitry to receive inputs in a spreadsheet file using the spreadsheet application. The user inputs include an origination, a destination, a start date and an end date. The apparatus also includes circuitry to store prices in the spreadsheet file, determine a travel cost estimate based on the inputs and the stored prices and render the travel cost estimate in the spreadsheet file.

In a still further aspect, the invention is a spreadsheet file to estimate travel costs stored on a storage medium. The spreadsheet file includes instructions causing a machine to receive inputs using a spreadsheet application. The user inputs include an origination, a destination, a start date and an end date. The spreadsheet file also includes instructions causing a machine to store prices including airfare prices, hotel prices and rental vehicle prices; store escalation factors comprising inflation factors; determine a travel cost estimate based on the inputs, the stored prices and the escalation factors; and render the travel cost estimate. A travel cost estimate determined from a copy of the spreadsheet file is the same as the travel cost estimate determined from the spreadsheet file.

### DESCRIPTION OF THE DRAWINGS

FIG. 1 is a block diagram of a computer system on which travel cost estimating may be implemented.

FIG. 2 is a flowchart of an example of a process to estimate travel costs.

FIG. 3 is a flowchart of an example of a process to receive inputs.

FIG. 4 is an example of an input spreadsheet used to receive the inputs.

FIG. 5 is a flowchart of an example of a process to determine a travel cost estimate.

FIG. 6 is an example of a prices spreadsheet.

FIG. 7 is an example of an escalation spreadsheet.

FIG. 8 is an example of an output spreadsheet used to render the travel cost estimate.

FIG. 9 is another example of an input spreadsheet used to receive the inputs.

### DETAILED DESCRIPTION

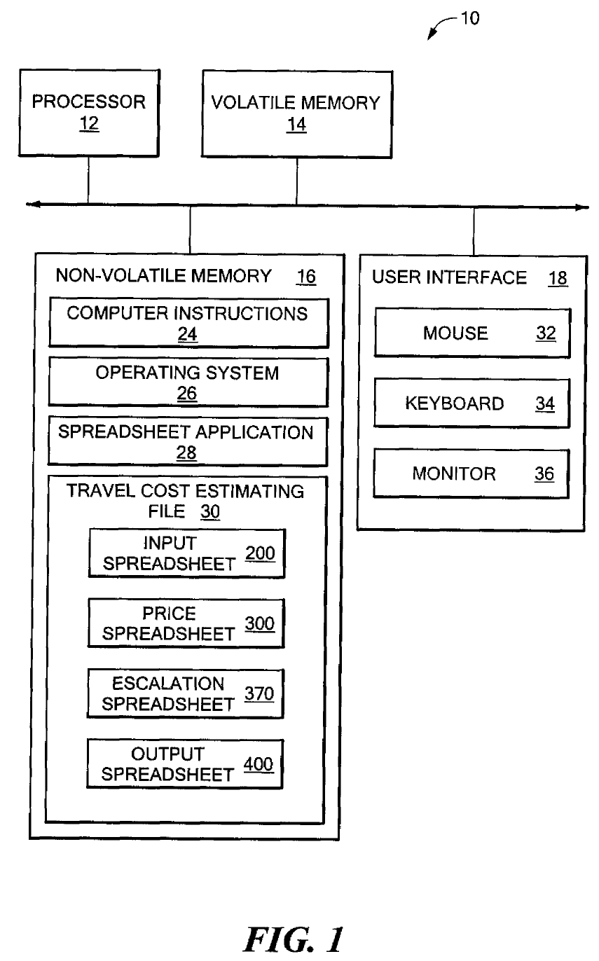

Referring to FIG. 1, a computer 10 used in travel cost estimating includes a processor 12, a volatile memory 14 and a non-volatile memory 16 (e.g., a hard disk). The non-volatile memory 16 includes computer instructions 24, an operating system 26, a spreadsheet application 28 and a travel cost estimating file 30. The user interface 18 includes a mouse 32, a keyboard 34 and a monitor 36.

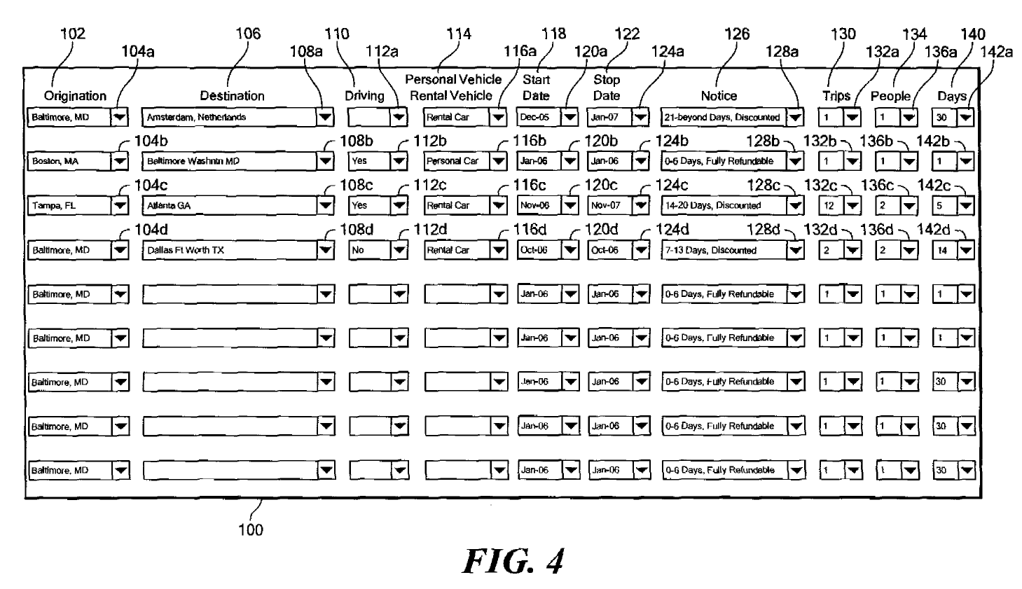

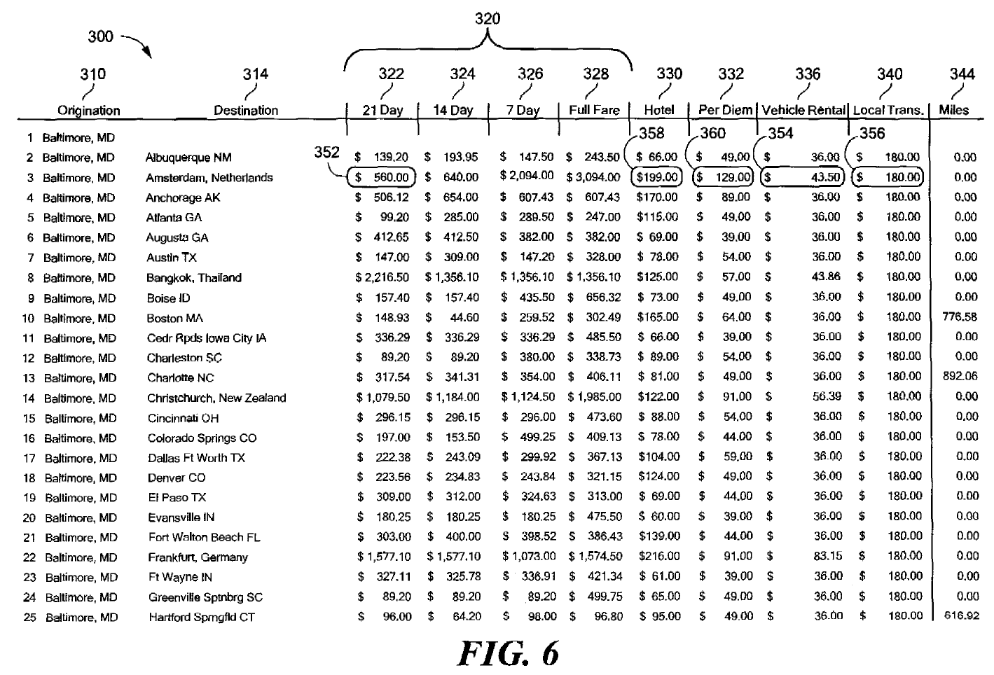

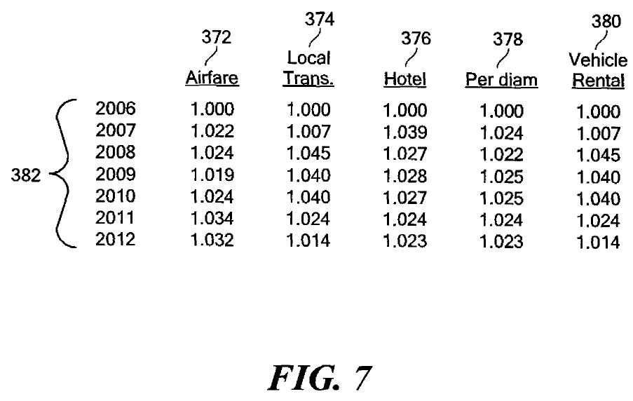

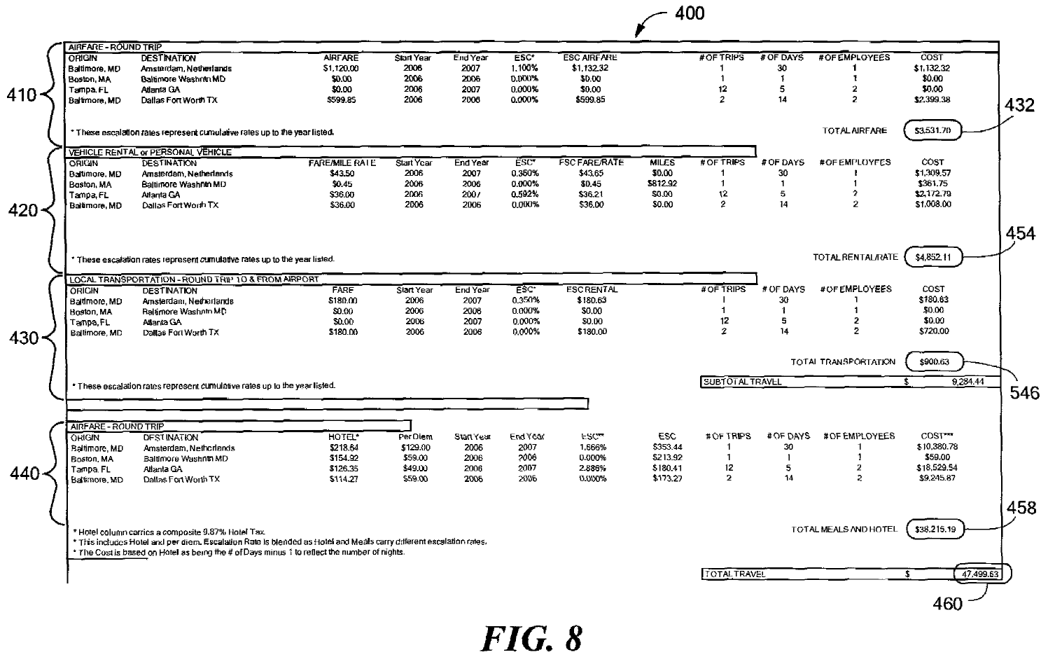

The travel cost estimating file 28 may include multiple spreadsheets (e.g., an input spreadsheet 100 (FIG. 4), a price spreadsheet 300 (FIG. 6), an escalation spreadsheet 370 (FIG. 7) and an output spreadsheet 400 (FIG. 8)). As will be described, a user, using the user interface 18, may access the travel cost estimating file 30 using the spreadsheet application 28 to estimate travel costs.

The travel cost estimating file 30 does not requires access to data outside of the computer 10 to determine travel cost estimates. In one example, the travel cost estimating file may be sent to cost estimators on a regular basis (e.g., quarterly, monthly) throughout a company to determine cost estimates on various projects the company is bidding on. Since the cost estimators are using the same travel cost estimating file 30, travel cost estimates reflect consistent pricing. For example, an estimator in Boston, Mass. may determine a trip cost estimate using the travel cost estimating file 30 to be the same estimate as an estimator in Los Angeles, Calif. using an identical version of the travel cost estimating file. Moreover, the travel cost estimating file 30 provides an auditable and repeatable process to determine travel cost estimates.

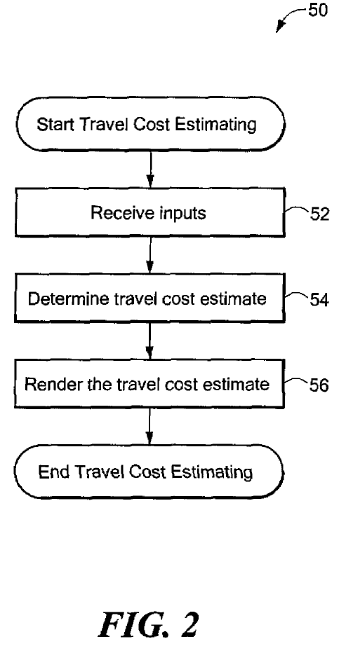

Referring to FIG. 2, an example of a process to determine a travel cost estimate is a process 50. Process 50 receives user inputs (52). Process 50 determines a travel cost estimate based on the user inputs (56). Process 50 renders the travel cost estimate (56). In one example, the computer instructions 24 (FIG. 1) are executed by processor 12 (FIG. 1) out of the volatile memory 14 to perform process 50.

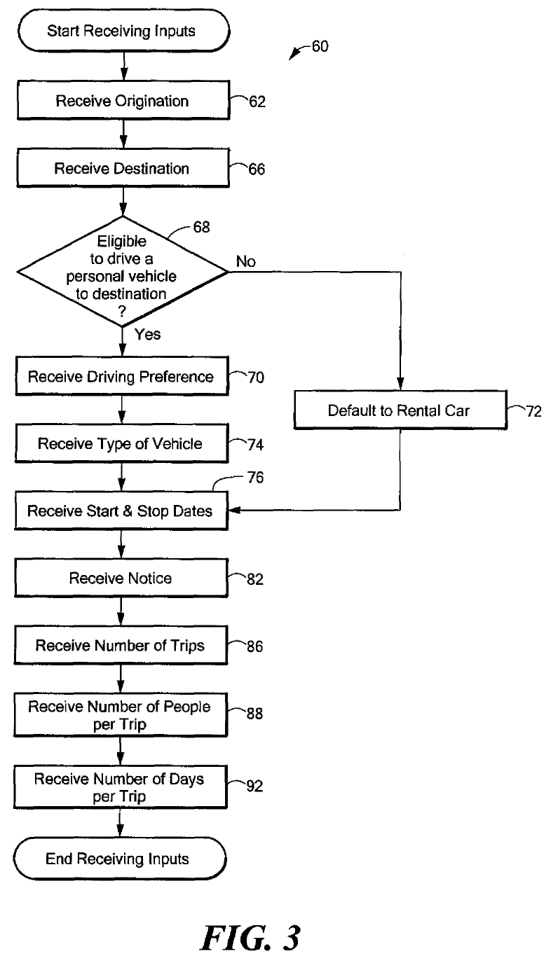

Referring to FIGS. 3 and 4, an example of a process to receive user inputs is a process 60. Process 60 uses an input spreadsheet 100 within the travel cost estimating file 30 to receive the user inputs. The input spreadsheet 100 includes an origination column 102, a destination column 106, a driving column 110, a personal vehicle/rental vehicle column 114, a start date column 118, a stop date column 122, a notice column 126, a trips column 130, a people column 134 and a days column 140.

The origination column 102 indicates an origination location of a trip. The origination column 102 includes pull-down menus 104 (e.g., a pull-down menu 104a, a pull-down menu 104b, a pull-down menu 104c, a pull-down menu 104d and so forth) that include a list of origination locations to be selected by the user. In one example, the pull-down down menu 104 includes a predetermined list of origination locations stored in a separate spreadsheet (not shown) within the travel cost estimating file 30.

The destination column 106 indicates a destination location of a trip. The destination column 106 includes pull-down menus 108 (e.g., a pull-down menu 108a, a pull-down menu 108b, a pull-down menu 108c, a pull-down menu 108d and so forth) that include a list of destination locations to be selected by the user. In one example, the pull-down menu 108 includes a predetermined list of destination locations stored in a separate spreadsheet (not shown) within the travel cost estimating file 30. In one example, the destination pull-down menus 108 render destination locations corresponding to the origination location selected. For example, if a user selected Boston as an origination location under a pull-down menu 104a, the pull-down menu 108a would render a first set of destination locations. However, if the user selected Los Angeles as an origination location, a second set of destination locations, different from the first set, would be rendered in the pull-down menu 108a. The generation of destination locations corresponding to an origination location may reflect the business requirements of a particular origination location.

The driving column 110 indicates whether a traveler will be driving from the origination to the destination. The driving column 110 includes pull-down menus 112 (e.g., a pull-down menu 112a, a pull-down menu 112b, a pull-down-menu 112c, a pull-down menu 112d and so forth) that include a “yes” entry, a “no” entry or a blank entry to indicate whether the traveler is using a vehicle. In one example, if a trip meets certain criteria (e.g., the trip is more than a predetermined amount of miles between the origination and the destination), the pull-down menu 112 is configured such that the user will be given an option to select the “no” entry or the “blank” entry but not an option to select the “yes” entry (e.g., the “yes” entry will not be rendered on the monitor 36). In one example, the blank entry equals the no entry in the pull-down menu 112 to account for situations where the user does not select the no entry.

The personal vehicle/rental vehicle column 114 indicates whether a traveler will be driving a personal vehicle or a rental vehicle. The personal vehicle/rental vehicle column 114 includes pull-down menus 116 (e.g., a pull-down menu 116a, a pull-down menu 116b, a pull-down menu 116c, a pull-down menu 116d and so forth) that include a “personal car” entry, a “rental car” entry or a blank entry. In one example, if the user selects the no entry or the blank entry in the corresponding pull-down menu 112 under the driving column 110, the pull-down menu 116 is configured such that the user will be given the option to select the “rental car” entry or the blank entry but not the personal car entry in the pull-down menu 116 (e.g., the “personal car” entry will not be rendered on the monitor 36).

The start column 118 indicates a start date of a trip. The start column 118 includes is pull-down menus 120 (e.g., a pull-down menu 120a, a pull-down menu 120b, a pull-down-menu 120c, a pull-down menu 120d and so forth) that include a list of dates to be selected by the user. For example, the dates may be in a month and year format.

The stop column 122 indicates a stop date of a trip. The stop column 106 includes pull-down menus 124 (e.g., a pull-down menu 124a, a pull-down menu 124b, a pull-down-menu 124c, a pull-down menu 124d and so forth) that include a list of dates to be selected by the user. For example, the dates may be in month and year format.

The notice column 126 indicates an amount of notice given for a trip used, for example, in determining airfares. The notice column 126 includes pull-down menus 128 (e.g., a pull-down menu 128a, a pull-down menu 128b, a pull-down-menu 128c, a pull-down menu 128d and so forth) that include a list of notices to be selected by the user. For example, the notices may be a “0 to 6 days” notice, “7 to 13 days” notice, “14 to 20 days” notice and a “greater than 21 days” notice.

The trips column 130 indicates an amount of trips. The trips column 130 includes pull-down menus 132 (e.g., a pull-down menu 132a, a pull-down menu 132b, a pull-down-menu 132c, a pull-down menu 132d and so forth) that include a list of numbers to be selected by the user.

The people column 134 indicates an amount of people on a trip. The people column 134 includes pull-down menus 136 (e.g., a pull-down menu 136a, a pull-down menu 136b, a pull-down-menu 136c, a pull-down menu 136d and so forth) that include a list of numbers to be selected by the user.

The days column 140 indicates an amount of days for a trip. The days column 130 includes pull-down menus 142 (e.g., a pull-down menu 142a, a pull-down menu 142b, a pull-down-menu 142c, a pull-down menu 142d and so forth) that include a list of numbers to be selected by the user.

Process 60 receives origination data (62). For example, a user uses the mouse 32 and a mouse cursor (not shown) to click the pull-down menu 104a under the origination column 102 and to select an origination location.

Process 60 receives the destination data (66). For example, the user uses the mouse 32 and the mouse cursor (not shown) to click the pull-down menu 108a under the destination column 106 and to select a destination location.

Process 60 determines if the user is eligible to drive from the origination to the destination using a personal vehicle (68). For example, the travel cost estimating file 30 may be configured such that travel by personal vehicle to certain destinations is not allowed. For another example, if an ocean separates the origination and the destination, the user would not be eligible to drive a personal vehicle. In still another example, if more than a predetermined amount of miles separated the origination and the destination, the user would not be eligible to drive a personal vehicle. In one example, if the trip is more than a predetermined amount of miles between the origination and the destination, the user will be given the option to select the “no” entry or the blank entry but not the “yes” entry in the pull-down menu 112 under the driving column 110. In another example, the travel cost estimating file 30 may be configured to reflect a user's organization travel policies with respect to use of a personal vehicle.

If the user is eligible to drive a personal vehicle, process 60 receives a driving preference from the user (70). Process 60 receives a vehicle type (74). For example, the user uses the mouse 32 under a rental vehicle/personal vehicle column 114 to click on pull-down menu 116 to make a selection between a rental vehicle entry, a personal vehicle entry or an option to leave the field blank. In one example, if the user selects the no entry or the blank entry under process block 70 (i.e., chooses not to drive), the user will only have the option to choose between the rental vehicle entry and the blank entry.

If the user is not eligible to drive a personal vehicle, process 60 defaults to a rental vehicle (72). In one example, the pull-down menu 116 provides only two entries: a blank entry and a rental vehicle entry. The blank entry equals the rental vehicle as a default selection for situations where the user does not overtly select the rental vehicle entry.

Process 60 receives start and stop information (76). For example, a user uses the mouse 32 and the mouse cursor (not shown) to click the pull-down menu 120a under the start date column 118 and to select a start date. The user also uses the mouse 32 and the mouse cursor to click the pull-down menu 124a under the stop date column 122 to select a stop date.

Process 60 receives the notice information (82). For example, a user uses the mouse 32 and the mouse cursor (not shown) to click the pull-down menu 128a under the notice column 126 to select a notice (e.g., the “0 to 6 days” notice, the “7 to 13 days” notice, the “14 to 20 days” notice and the “greater than 21 days” notice).

Process 60 receives a number of trips (86). For example, a user uses the mouse 32 and the mouse cursor (not shown) to click the pull-down menu 132a under the trips column 130 and to select a number of trips.

Process 60 receives a number of people (88). For example, a user uses the mouse 32 and the mouse cursor (not shown) to click the pull-down menu 136a under the people column 134 and to select a number of people.

Process 60 receives a number of days of a trip (92). For example, a user uses the mouse 32 and the mouse cursor (not shown) to click the pull-down menu 142a under the days column 140 and to select a number of days.

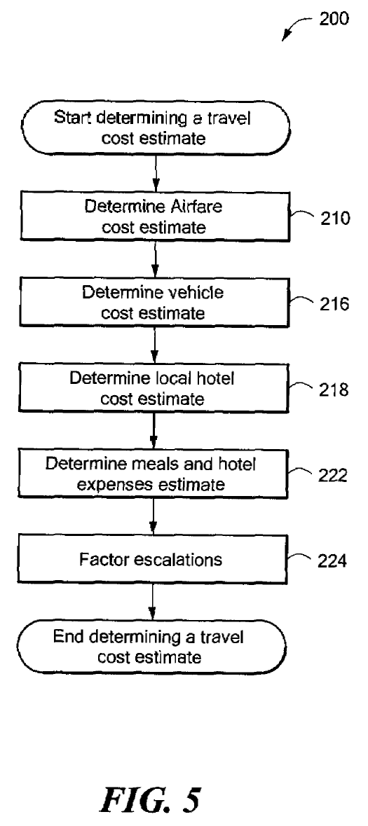

Referring to FIGS. 5 and 6, an example of a process to determine a travel cost estimate is a process 200. Process 200 uses a prices spreadsheet 300 (FIG. 6) within the travel cost estimating file 30 to determine the travel cost estimate. The prices spreadsheet includes prices in a base year (e.g., current quarterly update) dollars without escalation.

The prices spreadsheet 300 includes an origination column 310, a destination column 314, notice columns 320, a hotel column 330, a per diem column 332, a vehicle rental column 336, a local transportation column 340 and a miles column 344. The origination column 310 includes origination locations and the destinations column 314 includes destinations.

The notice column 320 includes a 21-day notice column 322 corresponding to the “greater than 21 days” notice, a 14-day notice column 324 corresponding to the “14 to 20 days” notice, a 7-day notice column 326 corresponding to the “7 to 13 days” notice and a full fare column 328 corresponding to the “0 to 6 days” notice. The notice columns 320 include corresponding airfares (one-way) based on the origination and destination locations.

The hotel column 330 includes daily hotel prices at the corresponding destination in the destination column 314. The per diem column 332 includes per diem rates, also known as a daily meal and incidentals rate, by destination location. The vehicle rental column 336 includes daily vehicle rental rates by destination. The local transportation column 340 includes transportation rates such as transportation to an airport, bus terminal, train station or other form of transit and covers for example, a limousine service, a car service, a taxi service, a shuttle service and so forth. The miles column 344 indicates miles between the origination and destination locations. As shown in FIG. 6, the miles column 344 indicates miles for trips less than 1,000 miles.

In one example, the airfare prices in the prices spreadsheet 300 reflect an average of the actual airfare prices incurred by a company over a period of time (e.g., in the past 12 months). The hotels and meals rates are actual General Services Administration (GSA) rates for a particular quarter. The vehicle rental rates reflect the actual corporate agreements with the company. In one example, the travel cost estimating file 30 is updated quarterly reflecting the rates and prices at that time.

Process 200 determines an airfare cost estimate (210). For example, based on the origination, destination and notice selected using the spreadsheet 100, process 200 determines the airfare from the spreadsheet 300. In one particular example, in the input spreadsheet 100 (FIG. 4), the user has selected an origination of Baltimore, MD using the pull-down menu 104a, a destination of Amsterdam, Netherlands using pull-down menu 108a and a notice of 21 days using the pull-down menu 128a. The corresponding airfare estimate is determined by using the price spreadsheet 300 and using a one-way airfare value in a spreadsheet cell 352 under the 21-day notice column 322 corresponding to a Baltimore, MD origination and an Amsterdam, Netherlands destination and multiplying by 2. For example, a $560 value in the cell 352 is multiplied by 2 resulting in an airfare of $1120 per person. The $1120 per person is further multiplied by the number of persons selected using the pull-down menu 136a and the number of trips selected in pull-down menu 132a further is resulting in an airfare of $1120.

Process 200 determines vehicle cost estimate (216). For example, based on whether the traveler uses a rental vehicle or a personal vehicle, process 200 uses the vehicle rental column 340. In one particular example, in the input spreadsheet 100 (FIG. 4), the user has selected an origination of Baltimore, MD using the pull-down menu 104a, a destination of Amsterdam, Netherlands using pull-down menu 108a and a rental car using the pull-down menu 114a. The vehicle cost estimate is determined by using the price spreadsheet 300 and using a rental vehicle price value in a spreadsheet cell 354 under the vehicle rental column 336 corresponding to a Baltimore, MD origination and an Amsterdam, Netherlands destination. For example, a $43.50 per day per person value in the cell 352 is multiplied by 30 days resulting in a vehicle rental estimate of $1305 per person. The $1305 per person is further multiplied by the number of persons selected using the pull-down menu 136a and the number of trips selected in pull-down menu 132a further resulting in a vehicle cost estimate of $1305.

In another example, the vehicle cost estimate may include additional logic so that every n persons, for example, is assigned a vehicle rental. For example, if n=4, then for every three people there is only one rental vehicle (not three rental vehicles as described above) so that: if there are four people, two rental vehicles; seven people, three rental vehicles and so forth.

In another particular example, in the input spreadsheet 100 (FIG. 4), the user has selected an origination of Boston, MA using the pull-down menu 104b, a destination of Baltimore-Washington International (BWI) Airport, MD using pull-down menu 108b and a personal car using the pull-down menu 114b. The personal vehicle cost estimate is determined by using the prices spreadsheet 300 and using miles from Boston to BWI, 812.92 miles under the miles column 344 (the portion of the prices spreadsheet 300 showing Boston to BWI not shown). For example, the 812.92 miles would be multiplied by a standard miles rate such as a cents per mile rate (for example, a cent per mile rate issued by the Federal Government). In 2006, for example, the standard rate was 45 cents per mile resulting in a $361.75 per person personal vehicle cost estimate. The $361.75 per person is further multiplied by the number of persons selected using the pull-down menu 136a and the number of trips selected in pull-down menu 132a further resulting in a vehicle cost estimate of $361.75.

Process 200 determines a local travel cost estimate (218). For example, process 200 uses the local transportation column 340 for the appropriate origination and destination and if the user indicated a no entry or a blank entry under the driving column 110. In one particular example, in the input spreadsheet 100 (FIG. 4), the user has selected an origination of Baltimore, MD using the pull-down menu 104a, a destination of Amsterdam, Netherlands using pull-down menu 108a and a blank entry using the pull-down menu 112a. The local transportation estimate is determined by using the price spreadsheet 300 and using a local transportation price value in a spreadsheet cell 356 under the local transportation column 340 corresponding to a Baltimore, MD origination and an Amsterdam, Netherlands, in this example, $180 per person round trip. The $180 per person is further multiplied by the number of persons selected using the pull-down menu 136a and the number of trips selected in pull-down menu 132a further resulting in a local transportation estimate of $180. In one example, the local transportation cost applies only when there is no option to drive or if the user chooses to fly if the option is to fly or drive. In another example, the travel cost estimating file 30 may include additional logic to account for a travel policy of a particular location within a company. For example, employees living in Tucson, Ariz. must drive to the airport in a personal vehicle, thus a local transportation cost would not be determined.

Process 200 determines meals and hotel expenses estimate (222). For example, process 200 uses the hotel rates from the hotel column 330 and the per diem rates in the per diem column 332. In one particular example, in the input spreadsheet 100 (FIG. 4), the user has selected an origination of Baltimore, MD using the pull-down menu 104a, a destination of Amsterdam, Netherlands using pull-down menu 108a and 30 days using the pull-down menu 142a. The hotel estimate is determined by using the price spreadsheet 300 and using a hotel price value in a spreadsheet cell 358 under the hotel column 330 corresponding to a Baltimore, MD origination and an Amsterdam, Netherlands, in this example, $199 per person per day and multiplying by 29 days (i.e., 30 days minus 1 day since the traveler does not require a hotel the day a traveler leaves a destination location) resulting in a $5771 per person.

The per diem estimate is determined by using the price spreadsheet 300 and using a per diem price value in a spreadsheet cell 360 under the per diem column 332 corresponding to a Baltimore, MD origination and an Amsterdam, Netherlands, in this example, $129/per person/per day and multiplying by 30 days resulting in a $3999 per person. The hotel expenses per person is added to the meals expenses per person resulting in $9,969 per person. The $9,969 per person is further multiplied by the number of persons selected using the pull-down menu 136a and the number of trips selected in pull-down menu 132a further resulting in a hotel and meals estimate of $9,969.

Process 200 factors escalations (ESC) (224). For example, process 200 scales the estimates based on projected escalation factors from year to year (e.g., escalation due to inflation, cost of living increases, consumer price index (CPI) changes and so forth). In one example, the escalation factors are depicted in an escalation spreadsheet 370 in FIG. 7. The spreadsheet includes an airfare escalation column 372, a local transportation price escalation column 374, a hotel price escalation column 376, a per diem price escalation column 378 and a vehicle rental escalation column 380 by listing escalation by years (a row of years 382).

In one particular example, in the input spreadsheet 100 (FIG. 4), the user has selected an origination of Baltimore, MD using the pull-down menu 104a, a destination of Amsterdam, Netherlands using pull-down menu 108a, a start date of December 2006 using pull-down menu 120a and a stop date of January 2007 using the pull-down menu 124a. In this example, the start date and end date occur in different years. Since the start date and stop date are in month increments, the travel cost estimating file 130 is configured to weight the trip by months in a year such that the travel cost estimating file 130 determines that one month is in 2006 (December 2006) and the other month is 2007 (January 2007). Since the escalations in 2006 are 1.000, weighted escalation factors may be determined by simply dividing the 2007 escalation factors by 2. Thus, the airfare estimate is multiplied by 1.022 corresponding to 2007 from the airfare escalation column 372 and divided by 2 to determine the total airfare estimate. Likewise, the rental vehicle cost estimate is multiplied by 1.007 corresponding to 2007 from the vehicle rental escalation column 380 and divided by 2 to determine the total rental vehicle cost estimate, the local transportation estimate is multiplied by 1.007 corresponding to 2007 from the local transportation escalation column 374 and divided by 2, the hotel estimate is multiplied by 1.039 from the hotel escalation column 376 and divided by 2 and the per diem estimate is multiplied by 1.024 corresponding to 2007 from the per diem escalation column 378 and divided by 2.

Referring to FIG. 8, an example of rendering the travel cost estimates is an output spreadsheet 400 in the travel cost estimating file 30. The output spreadsheet 400 includes an airfare estimate section 410, a rental vehicle/personal vehicle estimate section 420, a local transportation estimate section 430 and a hotel and meals estimate section 440. For example, a cell 452 indicates the airfare cost estimate, a cell 454 indicates the rental/personal vehicle cost estimate, a cell 456 indicates the local transportation cost estimate and a cell 468 indicates the hotels and meals cost estimate. A cell 460 indicates the total travel cost estimate.

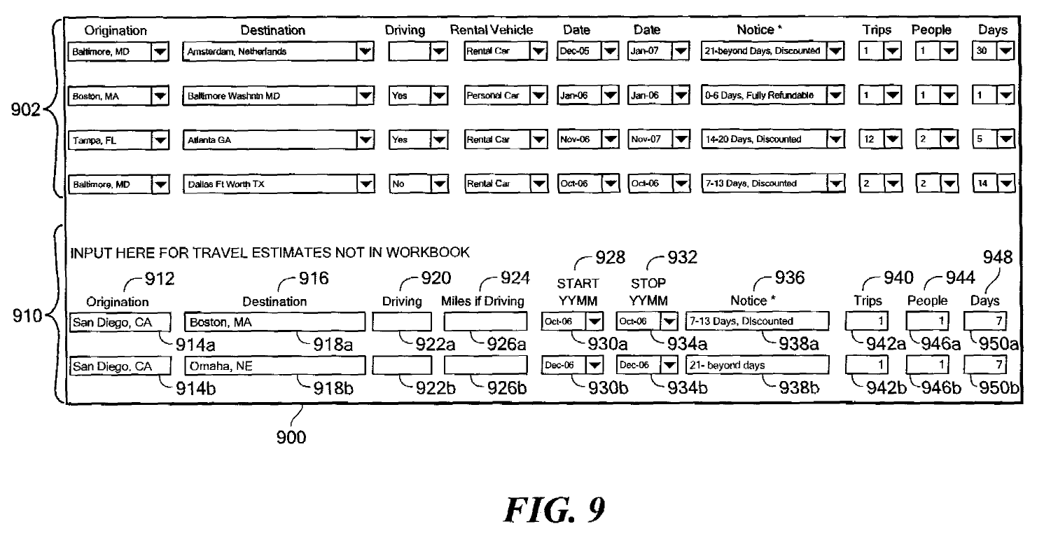

Referring to FIG. 9, in some situations, the origination locations and/or destination locations are not already included in the travel cost estimating file 30 or there are other travel costs not covered by the travel cost estimating file. In order to account for theses variances, an input sheet 900 includes a predetermined input section 902 and a manual input section 910 so that a user may manually enter the travel cost not already covered. The predetermined input section 902 includes all the fields and columns in the input spreadsheet 100. The manual input section 910 includes an origination column 912, a destination column 916, a driving column 920, a miles column 924, a start date column 928, a stop column 932, a notice column 936, a trips column 940, a people column 944 and a days column 948.

The origination column 912 includes fields (e.g., a field 914a and a field 914b) for a user to enter an origination location using the keyboard 34, for example. The destination column 916 includes fields (e.g., a field 918a and a field 918b) for a user to enter a destination location using the keyboard 34, for example. The driving column 920 includes fields (e.g., a field 922a and a field 922b) for a user to enter a driving preference using the keyboard 34, for example. The miles column 924 includes fields (e.g., a field 926a and a field 926b) for a user to enter a number of miles if driving using the keyboard 34, for example.

The start column 928 includes pull-down menus (e.g., a pull-down menu 930a and a pull-down menu 930b) for a user to select a start date (e.g., month and year) using the mouse 32, for example. The stop column 932 includes pull-down menus (e.g., a pull-down menu 934a and a pull-down menu 934b) for a user to select a start date (e.g., month and year) using the mouse 32, for example.

The notice column 936 includes fields (e.g., a field 938a and a field 938b) for a user to enter a notice using the keyboard 34, for example. The trips column 940 includes fields (e.g., a field 942a and a field 942b) for a user to enter a number of trips using the keyboard 34, for example. The people column 944 includes fields (e.g., a field 946a and a field 946b) for a user to enter a number of people on a trip using the keyboard 34, for example. The days column 948 includes fields (e.g., a field 950a and a field 950b) for a user to enter a number of trips using the keyboard 34, for example.

In one example, the data entered into the manual input section 910 may be directly transferred into corresponding columns and cells (not shown) in the output spreadsheet 400.

The travel cost estimating file 30 may also be configured to provide input to an external pricing proposal application. For example, an additional spreadsheet (not shown) may include fields formatted for receipt by the external pricing proposal application. In other examples, a user may execute a macro embedded in the spreadsheet file to generate a formatted file for receipt by the external pricing proposal application.

Process 50 is not limited to use with the hardware and software of FIG. 1; it may find applicability in any computing or processing environment and with any type of machine or set of machines that is capable of running a computer program. Process 50 may be implemented in hardware, software, or a combination of the two. Process 50 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 50 and to generate output information.

The system may be implemented, at least in part, via a computer program product, (i.e., a computer program tangibly embodied in an information carrier (e.g., in a machine-readable storage device or in a propagated signal)), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform process 50. Process 50 may also be implemented as a machine-readable storage medium, configured with a computer program, where upon execution, instructions in the computer program cause the computer to operate in accordance with process 50.

The processes described herein are not limited to the specific embodiments described herein. For example, the processes are not limited to the specific processing order of FIGS. 2 and 5. Rather, any of the blocks of FIGS. 2 and 5 may be re-ordered, combined or removed, performed in parallel or in serial, as necessary, to achieve the results set forth above. In another example, the spreadsheets described herein are not limited to the number described. The spreadsheets herein may be combined into fewer or one single spreadsheet or expanded to additional spreadsheets. In one example, the determining of the travel cost estimate and the rendering of the travel cost estimate may be performed on the same spreadsheet.

While the embodiments above describe determining cost estimates in a single currency (e.g., U.S. currency), the travel cost estimating file 30 may be further modified to include additional logic to convert estimates into one or more currencies. For example, a company using the travel cost estimating file 30 may have business units in a multiple countries. The travel cost estimating file 30 may convert from one currency (e.g., U.S. currency) to a second currency (e.g., Euros) where the business unit of the user is located.

The system described herein is not limited to use with the hardware and software described above. The system may be implemented in digital electronic circuitry, or in computer hardware, firmware, software, or in combinations thereof.

Method steps associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data.

Elements of different embodiments described herein may be combined to form other embodiments not specifically set forth above. Other embodiments not specifically described herein are also within the scope of the following claims.

What is claimed is:

1. A method to estimate travel costs using a spreadsheet application, comprising:
receiving inputs in a spreadsheet file using the spreadsheet application, the user inputs comprising an origination, a destination, a start date and an end date;
storing prices in the spreadsheet file;
determining a travel cost estimate based on the inputs and the stored prices; and
rendering the travel cost estimate in the spreadsheet file.

2. The method of claim 1, further comprising making a copy of the spreadsheet file, wherein a travel cost estimate determined from the copy of the spread sheet file is the same as the travel cost estimate determined from the spreadsheet file.

3. The method of claim 2 further comprising storing escalation factors comprising storing inflation factors.

4. The method of claim 3 wherein determining the travel cost estimate comprises determining a travel cost estimate based on the inputs, the stored prices and the escalation factors.

5. The method of claim 1 wherein storing prices comprises storing prices based on average historical prices.

6. The method of claim 1 wherein storing prices comprises storing airfare prices, hotel prices and rental vehicle prices.

7. The method of claim 1, further comprising configuring the travel cost estimate for receipt by a pricing proposal application.

8. The method of claim 1 wherein receiving inputs in a spreadsheet file comprises receiving inputs from the user selecting predetermined data using pull-down menus.

9. The method of claim 8 wherein receiving inputs in a spreadsheet file comprises receiving inputs from the user entering data using a keyboard.

10. The method of claim 1, further comprising providing an update of the spreadsheet file to the user on a regular basis.

11. An article comprising a machine-readable medium that stores executable instructions to estimate travel costs, the instructions causing a machine to:
receive inputs in a spreadsheet file using the spreadsheet application, the user inputs comprising an origination, a destination, a start date and an end date;
store prices in the spreadsheet file;
determine a travel cost estimate based on the inputs and the stored prices; and
render the travel cost estimate in the spreadsheet file.

12. The article of claim 11, further comprising instructions causing a machine to store escalation factors.

13. The article of claim 12 wherein the instructions causing a machine to determine the travel cost estimate comprises instructions causing the machine to determine a travel cost estimate based on the inputs, the stored prices and the escalation factors.

14. The article of claim 11 wherein the instructions causing a machine to store prices comprises instructions causing a machine to store airfare prices, hotel prices and rental vehicle prices.

15. The article of claim 11, further comprising instructions causing a machine to configure the travel cost estimate for receipt by a pricing proposal application.

16. An apparatus to estimate travel costs, comprising:
circuitry to:
receive inputs in a spreadsheet file using the spreadsheet application, the user inputs comprising an origination, a destination, a start date and an end date;
store prices in the spreadsheet file;
determine a travel cost estimate based on the inputs and the stored prices;
and
render the travel cost estimate in the spreadsheet file.

17. The apparatus of claim 16 wherein the circuitry comprises at least one of a processor, a memory, programmable logic and logic gates.

18. The apparatus of claim 16, further comprising circuitry to store escalation factors.

19. The apparatus of claim 18 wherein the circuitry to determine the travel cost estimate comprises circuitry to determine a travel cost estimate based on the inputs, the stored prices and the escalation factors.

20. The apparatus of claim 16 wherein the circuitry to store prices comprises circuitry to store airfare prices, hotel prices and rental vehicle prices.

21. The apparatus of claim 16, further comprising circuitry to configure the travel cost estimate for receipt by a pricing proposal application.

22. A spreadsheet file to estimate travel costs stored on a storage medium, the spreadsheet file comprising:
instructions causing a machine to:
receive inputs using a spreadsheet application, the user inputs comprising an origination, a destination, a start date and an end date;
store prices comprising airfare prices, hotel prices and rental vehicle prices;
store escalation factors comprising inflation factors.
determine a travel cost estimate based on the inputs, the stored prices and the escalation factors; and
render the travel cost estimate;
wherein a travel cost estimate determined from a copy of the spread sheet file is the same as the travel cost estimate determined from the spreadsheet file.

23. The spreadsheet file of claim 22, further comprising instructions causing a machine to configure the travel cost estimate for receipt by a pricing proposal application.

24. The spreadsheet file of claim 22 wherein the instructions causing a machine to store prices comprise instructions causing a machine to store prices based on average historical prices.

25. The spreadsheet file of claim 22 wherein the instructions causing a machine to receive inputs comprise instructions causing a machine to receive inputs from the user selecting predetermined data using pull-down menus.

26. The spreadsheet file of claim 22 wherein the instructions causing a machine to receive inputs in a spreadsheet file comprise instructions causing a machine to receive inputs from the user entering data using a keyboard.
